(19) United States
(12) Patent Application Publication
(10) Pub. No.: US 2010/0128100 A1
(43) Pub. Date: May 27, 2010

(54) IMAGING FEATURES WITH A PLURALITY OF SCANS

(76) Inventor: Aldo Salvestro, Burnaby (CA)

Correspondence Address: EASTMAN KODAK COMPANY;PATENT LEGAL STAFF, 343 STATE STREET, ROCHESTER, NY, 14650-2201, US

(21) Appl. No.: 12/596,845

(22) PCT Filed: Apr. 26, 2007
(86) PCT No.: PCT/IB07/01093

§ 371 Date: Oct. 21, 2009

(51) Int. Cl. B41J 2/32

(52) U.S. Cl. 347/171

(57) ABSTRACT

A method is provided for forming an image, such as a chevron or other irregularly shaped image on a media. The method includes operating an imaging head to direct imaging beams to form a first portion of the image on the media while scanning over the media along a first scan path during a first scan and operating the imaging head to direct imaging beams to form a second portion of the image on the media while scanning over the receiver element along a second scan path during a second scan where the first scan path is not parallel to the second scan path.

### TECHNICAL FIELD

The invention relates to imaging systems and to methods for forming features. The invention may be applied to fabricating color filters for electronic displays, for example.

### BACKGROUND

Color filters used in display panels typically include a pattern comprising a plurality of color features. The color features may include patterns of red, green and/or blue color features, for example. Color filters may be made with color features of other colors. The color features may be arranged in any of various suitable configurations. Prior art stripe configurations have alternating columns of red, green and blue color features as shown in FIG. 1A.

FIG. 1A shows a portion of a prior art “stripe configuration” color filter 10 having a plurality of red, green and blue color features 12, 14 and 16 respectively formed in alternating columns across a receiver element 18. Color features 12, 14 and 16 are outlined by portions of a color filter matrix 20 (also referred to as matrix 20). The columns can be imaged in elongated stripes that are subdivided by matrix cells 34 (also referred to as cells 34) into individual color features 12, 14 and 16. TFT transistors on the associated LCD panel (not shown) may be masked by areas 22 of matrix 20.

Laser-induced thermal transfer processes have been proposed for use in the fabrication of displays, and in particular color filters. In some manufacturing techniques, when laser-induced thermal transfer processes are used to produce a color filter, a color filter substrate also known as a receiver element is overlaid with a donor element that is then image-wise exposed to selectively transfer a colorant from the donor element to the receiver element. Preferred exposure methods use radiation beams such as laser beams to induce the transfer of the colorant to the receiver element. Diode lasers are particularly preferred for their low cost and small size.

Laser induced “thermal transfer” processes include: laser induced “dye transfer” processes, laser-induced “melt transfer” processes, laser-induced “ablation transfer” processes, and laser-induced “mass transfer” processes. Colorants transferred during laser-induced thermal transfer processes include suitable dye-based or pigment-based compositions. Additional elements such as one or more binders may be transferred.

Some conventional laser imaging systems have employed a limited number of imaging beams. Other conventional systems have employed hundreds of individually-modulated beams in parallel to reduce the time taken to complete images. Imaging heads with large numbers of such “channels” are readily available. For example, a SQUAREspot® model thermal imaging head manufactured by Kodak Graphic Communications Canada Company, British Columbia, Canada has several hundred independent channels. Each channel can have power in excess of 25 mW. An array of imaging channels can be controlled to write an image in a series of image swaths which are closely abutted to form a continuous image.

The stripe configuration shown in FIG. 1A illustrates one example configuration of color filter features. Color filters may have other configurations. Mosaic configurations have the color features that alternate in both directions (e.g. along columns and rows) such that each color feature resembles an “island”. Delta configurations (not-shown) have groups of red, green and blue color features arranged in a triangular relationship to each other. Mosaic and delta configurations are examples of “island” configurations. FIG. 1B shows a portion of a prior art color filter 10 arranged in a mosaic configuration in which color features 12, 14 and 16 are arranged in columns and alternate both across and along the columns.

Other color filter configurations are also known in the art. Whereas the illustrated examples described above show patterns of rectangular shaped color filter elements, other patterns including other shaped features are also known.

FIG. 1C shows a portion of a prior art color filter 10 with a configuration of triangular shaped color features 12A, 14A and 16A. As illustrated in FIG. 1C, each of the respective color features are arranged along columns and are separated by matrix 20.

FIG. 1D shows a portion of a prior art color filter 10 with a configuration of triangular shaped color features 12A, 14A and 16A. As illustrated in FIG. 1D, each of the respective color features alternate along the columns and rows of color filter 10. As shown in FIGS. 1C and 1D, color features 12A, 14A and 16A can have different orientations within a given row or column.

FIG. 1E shows a portion of a prior art color filter 10 that includes a configuration of chevron shaped color features 12B, 14B and 16B. As illustrated in FIG. 1E, each of the respective color features are arranged along columns and are separated by matrix 20. Color features 12B, 14B and 16B are formed from “zig-zag”color stripes and are outlined by portions of a color filter matrix 20.

FIG. 1F shows a portion of a prior art color filter 10 that includes a configuration of chevron shaped color features 12B, 14B and 16B. As illustrated in FIG. 1F, each of the respective color features alternate in along the columns and rows of color filter 10.

The shape and configuration of a color filter feature can be selected to provide desired color filter attributes such as a better color mix or enhanced viewing angles. Features whose shapes or orientations vary can create additional challenges when the color features are formed by various imaging processes.

In some applications, it is required that features be formed in substantial alignment with a registration region provided on a receiver element. For example, in some color filter applications, color features are to be aligned with a pattern of matrix cells 34 that are provided by matrix 20. The color features can overlap matrix 20 to reduce leakage of backlight between the features. In applications such as color filters, the visual quality of the final product is dependant upon the accuracy that a repeating pattern of features (e.g. the pattern of color filter features) is registered with a repeating pattern of registration sub-regions (e.g. a color filter matrix). Misregistration can lead to the formation of undesired colorless voids and/or the overlapping of adjacent color features which can result in an undesired color combination.

Overlapping a matrix 20 can help to reduce the precision with which the color features must be registered with matrix 20. However, there typically are limits to the extent that a matrix 20 can be overlapped. Factors that can limit the degree of overlap (and final registration) can include, but are not limited to: the particular configuration of the color filter, the width of the matrix lines, the roughness of the of the matrix lines, the minimum overlap required to prevent back light leakage, and post annealing color features shrinkage.

Factors associated with the particular method employed to form the features can limit the degree of overlap. For example, when laser imaging methods are employed, the precision with which the laser imager can scan the color filter will affect the final registration obtained. The addressability associated with the imaging channels of the imaging head defines the resolution with which the features can be imaged, and has a bearing on the final registration. The addressability associated with the imaging channels of the imaging head defines a size characteristic of a pixel imaged by an imaging beam. The orientation of the color filter with respect the imaging head can also have a bearing on the registration.

There remains a need for effective and practical imaging methods and systems that permit making high-quality images of features. Various portions of these features can have different orientations with respect to a scan path. Various edges of these features can have different orientations with respect to a scan path.

There remains a need for imaging methods that that can form images of features in substantial alignment with a pattern of registration sub-regions provided on a media. Various portions of these features can have different orientations with respect to a scan path. Various edges of these features can have different orientations with respect to a scan path.

### SUMMARY OF THE INVENTION

The present invention relates to imaging features on media. The features can be a repeating pattern of features. In one embodiment, the repeating pattern of features can be a repeating pattern of island features, which can include a pattern of features of one color separated from each other by features of another color. The image can include chevron shaped features or irregularly shaped features

In some embodiments, the image can be formed by a laser-induced thermal transfer process, laser-induced dye-transfer process, laser-induced mass transfer process, or by transferring an image forming material from a donor element to a receiver element. In one embodiment, the image can be colored illumination sources for organic light emitting diodes.

The present invention provides a method for operating an imaging head to direct imaging beams to form a first portion of the image on the media while scanning over the media along a first scan path during a first scan; and operating the imaging head to direct imaging beams to form a second portion of the image on the media while scanning over the receiver element along a second scan path during a second scan. The first scan path may not be parallel to the second scan path. The image can include portions which are skewed with respect to a main scan direction. In one embodiment, the image data can be separated into portions corresponding to the first portion of the image and the second portion of the image.

In some embodiments, the first portion of the image has a portion of a feature, and the portion of the feature is parallel to the first scan path. In another embodiment, the first portion of the image has a portion of a feature, and at least one edge of the portion of the feature is parallel to the first scan path. The second portion of the image can include an additional portion of the feature which is parallel with a second scan path. In another embodiment, at least one edge of the additional portion of the feature is parallel with the second scan path. In one embodiment, first and second portions of features can be overlapped with one another.

During the scans, relative motion between the imaging head and the media can be established. Either the imaging head can be moved or the media can be moved. It is also possible to move both at the same time. The scan paths of first and second scans can be different from one another. The paths can be different in direction and length.

### BRIEF DESCRIPTION OF THE DRAWINGS

Embodiments and applications of the invention are illustrated by the attached non-limiting drawings. The attached drawings are for purposes of illustrating the concepts of the invention and may not be to scale.

FIG. 1A is a plan view of a portion of a prior art color filter;

FIG. 1B is a plan view of a portion of another prior art color filter;

FIG. 1C is a plan view of a portion of a prior art filter including triangular shaped features;

FIG. 1D is a plan view of a portion of another prior art filter including triangular shaped features;

FIG. 1E is a plan view of a portion of a prior art filter including chevron shaped features;

FIG. 1F is a plan view of a portion of another prior art filter including chevron shaped features;

FIG. 2 is a schematic representation of a multi-channel head imaging a pattern of features onto an imageable media;

FIG. 3 is a schematic perspective view of the optical system of an example prior art multi-channel imaging head;

FIG. 4A is a is a schematic view of an example pattern of features that is desired to be formed on an imageable media with an imaging head;

FIG. 4B is a schematic view of an imaged feature having stair-cased edges;

FIG. 5A is a schematic representation of two color features and a matrix portion;

FIG. 5B is a schematic representation of two color features having stair-cased edges and a matrix portion;

FIG. 6 is a schematic representation of the device of the present invention shown in conjunction with imageable media;

FIG. 7 is a flow chart for an imaging method of an example embodiment of the invention;

FIG. 8A is a schematic representation of a multi-channel head imaging a portion of the pattern of features of FIG. 4A onto an imageable media as per an example embodiment of the invention;

FIG. 8B is a schematic representation of a multi-channel head imaging an additional portion of the pattern of features of FIG. 4A onto an imageable media as per an example embodiment of the invention; and

FIG. 8C is a schematic representation of two portions of a feature on an imageable media formed as per an example embodiment of the invention.

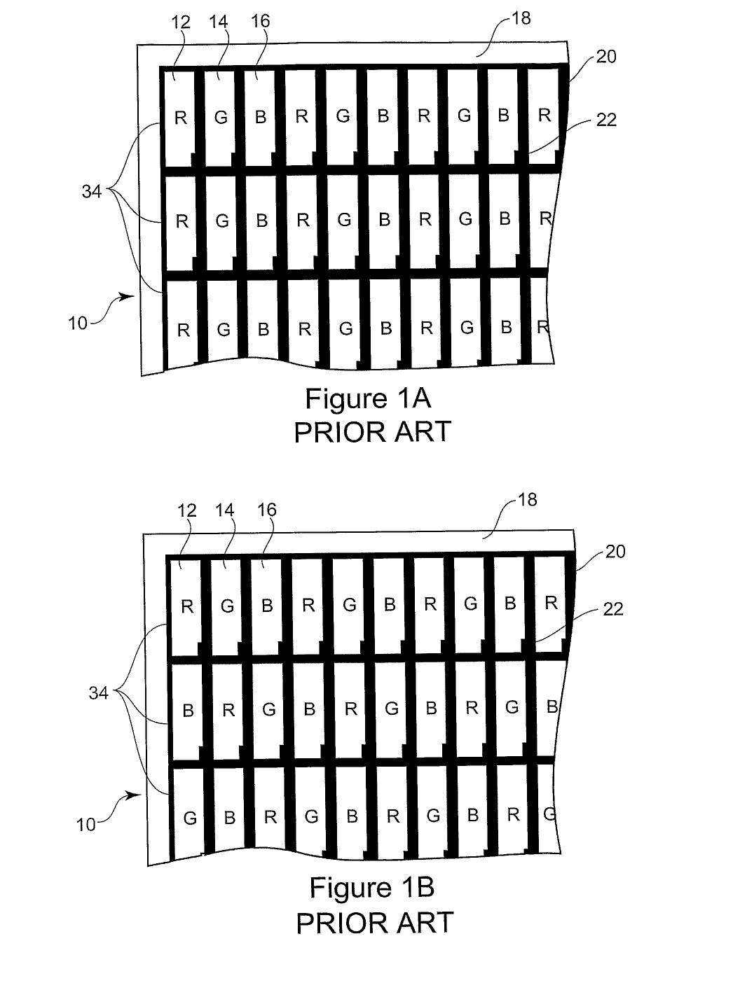

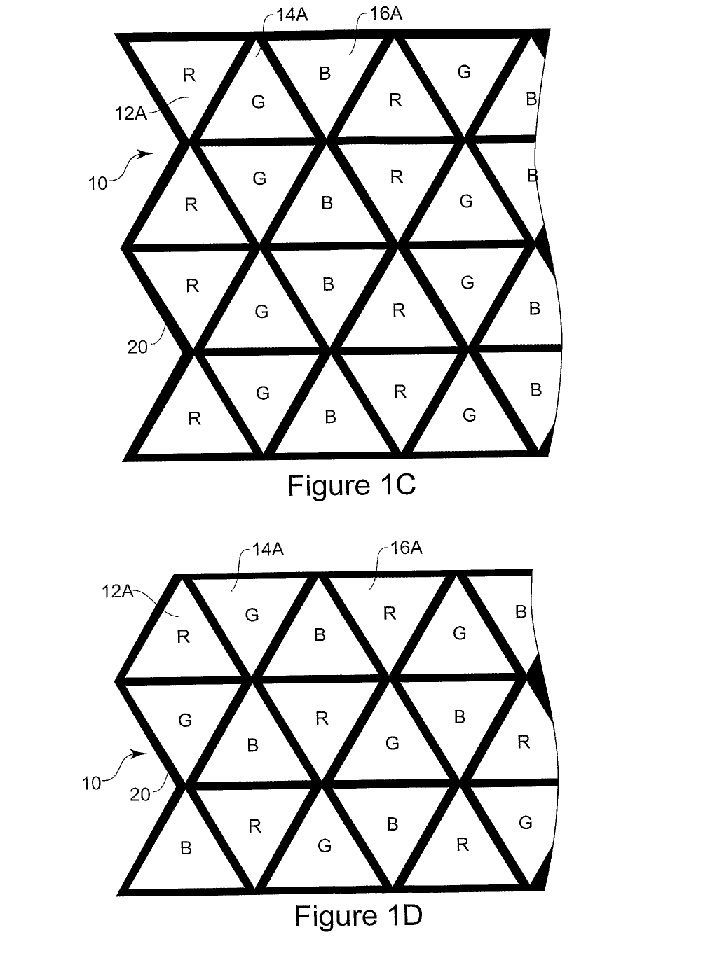

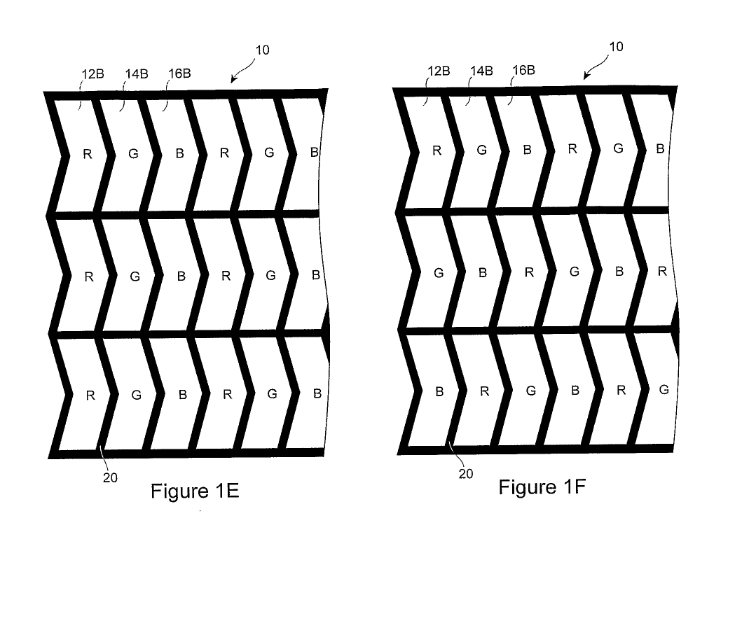

### DETAILED DESCRIPTION

Throughout the following description specific details are presented to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense.

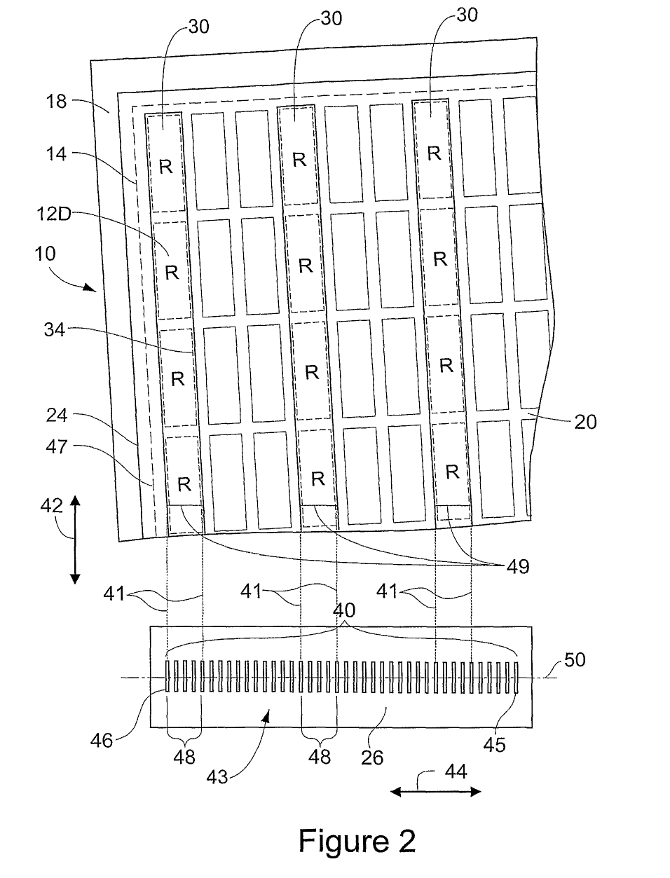

FIG. 2 shows a conventional laser-induced thermal transfer process being used to fabricate a color filter 10. An imaging head 26 is provided to transfer image-forming material (not shown) from a donor element 24 to an underlying receiver element 18. Donor element 24 is shown as being smaller than receiver element 18 for the purposes of clarity only. Donor element 24 may overlap one or more portions of receiver element 18 as may be required. Imaging head 26 can include one or more imaging channels. In this case, imaging head includes a channel array 43 of individually addressable channels 40. In some cases channel array 43 can be a one dimensional array. In some cases the channel array 43 can be a two dimensional array.

Receiver element 18 can include a registration region with which it is desired to form images of one or more features in substantial alignment. Receiver element 18 can include a pattern of registration sub-regions with which it is desired to form images of one or more features in substantial alignment. In this case, receiver element 18 includes a registration region 47 (schematically represented in large broken lines). In this case, registration region 47 includes a matrix 20. Matrix 20 is an example of a pattern of registration sub-regions. Although a laser-induced thermal transfer process could be used to form matrix 20 on receiver element 18, matrix 20 is typically formed by lithographic techniques.

Donor element 24 includes an image-forming material (not shown) that can be image-wise transferred onto the receiver element 18 when imaging beams emitted by imaging head 26 are scanned across donor element 24. Red, green and blue portions of filter 10 are typically imaged in separate imaging steps, each imaging step using a different color donor element appropriate for the color to be imaged. The red, green and blue features of the filter are typically transferred to receiver element 18 such that the color features are to be substantially aligned with a corresponding matrix cell 34. Each donor element 24 is removed upon completion of the corresponding imaging step. After the color features have been transferred, the imaged color filter may be subjected to one or more additional process steps, such as an annealing step for example, to change one or more physical properties (e.g. hardness) of the imaged color features.

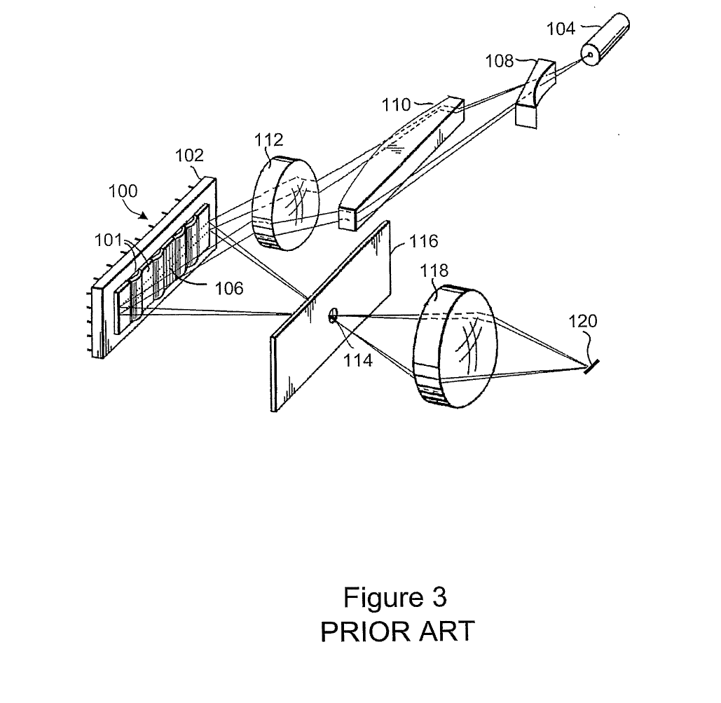

An example of an illumination system employed by a conventional laser-based multi-channel imaging process is schematically shown in FIG. 3. A spatial light modulator or light valve is used to create a plurality of imaging channels. In the illustrated example, linear light valve array 100 includes a plurality of deformable mirror elements 101 fabricated on a semi-conductor substrate 102. Mirror elements 101 are individually addressable. Mirror elements 101 can be micro-electro-mechanical (MEMS) elements, such as deformable mirror micro-elements, for example. A laser 104 can generate an illumination line 106 on light valve 100 using an anamorphic beam expander comprising cylindrical lenses 108 and 110. Illumination line 106 is laterally spread across the plurality of elements 101 so that each of the mirror elements 101 is illuminated by a portion of illumination line 106. U.S. Pat. No. 5,517,359 to Gelbart describes a method for forming an illumination line.

A lens 112 typically focuses laser illumination through an aperture 114 in an aperture stop 116 when elements 101 are in their un-actuated state. Light from actuated elements is blocked by aperture stop 116. A lens 118 images light valve 100 to form a plurality of individual image-wise modulated beams 120, which can be scanned over the area of a substrate to form an imaged swath. Each of the beams is controlled by one of the elements 101. Each element 101 controls a channel of a multi-channel imaging head.

Each of the beams is operable for imaging, or not imaging, an “image pixel” on the imaged receiver element in accordance with the driven state of the corresponding element 101. That is, when required to image a pixel in accordance with the image data, a given element 101 is driven to produce a corresponding beam with an active intensity level suitable for imparting a pixel image on the substrate. When required not to image a pixel in accordance with the image data, a given element 101 is driven to not produce an imaging beam. As used herein, pixel refers to a single element of image on the substrate, as distinguished from the usage of the word pixel in connection with a portion of an image displayed on an assembled display device. For example, if the present invention is used to create a filter for a color display, the pixels created by the present invention will be combined with adjacent pixels, to form a single pixel (also referred to as a feature) of an image displayed on the display device.

FIG. 2 shows a portion of a color filter receiver element 18 that has been conventionally patterned with a plurality of red stripes 30 in a laser-induced thermal transfer process. FIG. 2 depicts the correspondence between imaging channels 40 and the transferred pattern as broken lines 41. Features, such as stripes 30 generally have sizes that are greater than a width of a pixel imaged by an imaging channel 40. The imaging beams generated by imaging head 26 are scanned over receiver element 18 while being image-wise modulated according to image data specifying the pattern of features to be written. Groups 48 of channels are driven appropriately to produce imaging beams with active intensity levels wherever it is desired to form a feature. Channels 40 not corresponding to the features are driven so as not to image corresponding areas. Channel groups 48 are activated to direct imaging beams to form a scanning imaging line 49 used to form the features.

Receiver element 18, imaging head 26, or a combination of both, are moved relative to one another while the channels 40 of the imaging head 26 are controlled in response to image data to create image swaths. In some cases imaging head 26 is stationary and receiver element 18 is moved. In other cases receiver element 18 is stationary and imaging head 26 is moved. In still other cases, both the imaging head 26 and the receiver element 18 are moved.

Channels 40 of imaging head 26 can image an image swath having a width related to the distance between a first pixel imaged by a first channel 46 and a last pixel imaged by a last channel 45. Receiver element 18 can be too large to be imaged within a single image swath. Therefore, multiple scans of imaging head 26 are typically required to complete an image on receiver element 18.

Movement of imaging head 26 along sub-scan axis 44 may occur after the imaging of each swath is completed along main-scan axis 42. Alternatively, with a drum-type imager, it may be possible to relatively move imaging head 26 along both the main-scan axis 42 and sub-scan axis 44, thus writing the image in swath extending helically on the drum. In FIG. 2, relative motion between imaging head 26 and receiver element 18 can be provided along a path aligned with main-scan axis 42. In FIG. 2, relative motion between imaging head 26 and receiver element 18 can be provided along a path aligned with sub-scan axis 44.

Any suitable mechanism may be applied to move imaging head 26 over a receiver element 18. Flat bed imagers are typically used for imaging receiver elements 18 that are relatively rigid, as is common in fabricating display panels. A flat bed imager has a support that secures a receiver element 18 in a flat orientation. U.S. Pat. No. 6,957,773 to Gelbart describes a high-speed flatbed imager suitable for display panel imaging. Alternatively, flexible receiver elements 18 can be secured to either an external or internal surface of a “drum-type” support to affect the imaging of the image swaths.

In FIG. 2, registration region 47 and associated matrix 20 are skewed with respect to sub-scan axis 44. Registration region 47 and associated matrix 20 are skewed with respect to an axis 50 of the array of channels 40. Registration region 47 and associated matrix 20 are skewed with respect to imaging lines 49. Skewed features or features with skewed edges have been imaged by establishing controlled relative motion between receiver element 18 and imaging head 26 as imaging head 26 directs imaging beams along scan paths. In this case, sub-scan motion is coordinated with main-scan motion in accordance with the amount of skew. As main-scan motion is provided between imaging head 26 and receiver element 18, synchronous sub-scan motion is also provided between imaging 26 and receiver element 18 to create a motion also referred to as coordinated motion. Unlike drum-based imaging methods where image swaths are imaged in a helical fashion wherein the amount of sub-scan motion during each rotation is typically defined independently of the image to be formed, the amount of sub-motion during each scan is dependant on the image to be formed when coordinated motion techniques are employed. Coordinated motion can be used to align scan paths with feature orientations. For example, the imaging head 26 is moved along a first path aligned with sub-scan axis 44 while receiver element 18 is synchronously moved along a second path aligned with main-scan axis 42. The movement along the first and second paths is controlled to align various scan paths with an orientation of a feature to be imaged. Coordinated motion can be used to form features with edges that are substantially smooth and continuous which in some demanding applications can be used to facilitate an alignment of a pattern of features with a pattern of registration sub-regions.

As shown in FIG. 2, portions of each red stripe 30 completely overlap portions of matrix 20 along a direction aligned with main-scan axis 42 and partially overlap other portions of matrix 20 along a direction aligned with sub-scan axis 44. Overlapping matrix 20 reduces the precision with which the red stripes 30 must be registered with matrix 20. Overlapping matrix 20 also reduces backlighting effects between the elements that can adversely impact the quality of color filter 10.

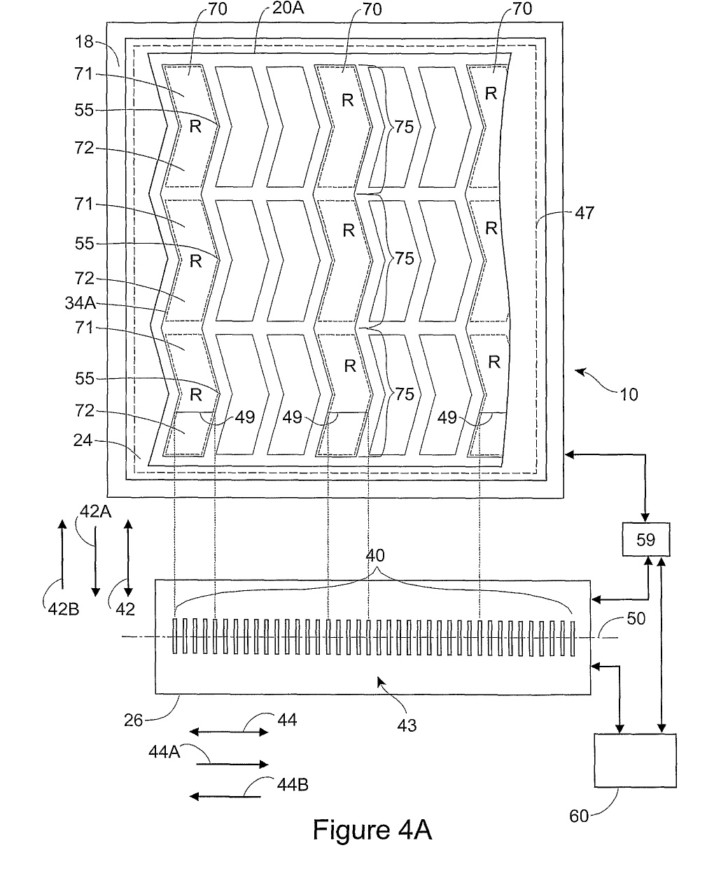

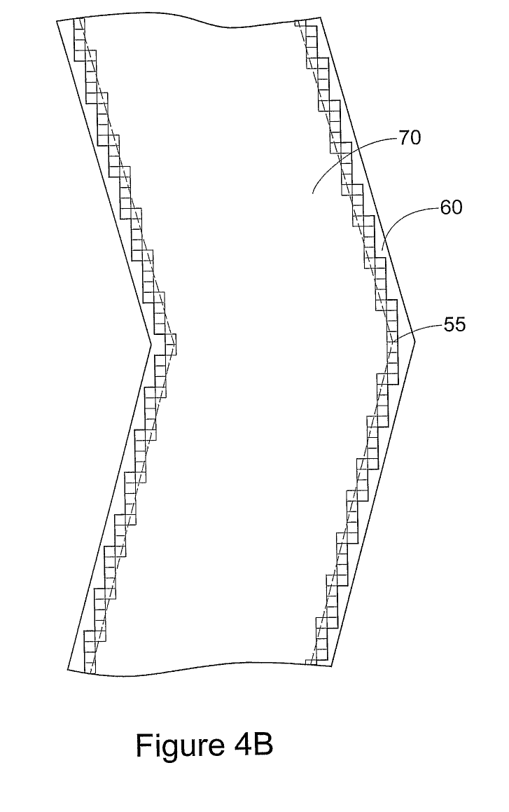

FIG. 4A shows a portion of a color filter 10 including a plurality of stripe features 70. For the sake of clarity only red stripe color features are shown. One skilled in the art will realize that other color features can also be formed. Features 70 include portions of varying angles with respect to axis 50. It is desired that stripe features 70 be formed by an imaging process employing an imaging head. In this case the desired imaging process includes an imaging head 26 that includes a channel array 43 of individually addressable channels 40. In this case, imaging head 26 is to be controlled to image donor element 24 to transfer of an image forming material (not shown) to form zig-zag like stripe features 70 on receiver element 18. Color filter features comprising a chevron shape are delineated by matrix 20A in areas corresponding to the transferred stripe features 70.

Image forming material is to be transferred to receiver element 18 such that it forms the varying angled portions of each of the stripe features 70. Although it is possible to form stripe features 70 by employing conventional coordinated motion techniques during the imaging process, these techniques can reduce the productivity of the imaging process. Coordinated motion techniques used during the imaging of features such as zig-zag stripe features 70 would require a reciprocating form of motion. For example, as imaging head 26 is moved relative to receiver element 18 along main-scan axis 42, imaging head 26 would need to synchronously reciprocate with respect to receiver element 18 along sub-scan axis 44 to follow the zig-zag shaped features. The movement mechanism used to establish the required relative sub-scan and main-scan relative motion between imaging head 26 and receiver element 18 would need to deal with high deceleration/acceleration forces that would be required to move about various corners (e.g. corner portion 55) of each stripe feature 70. The following equations can be used to illustrate this situation:

Vsubscan=Vmainscan*sin θ, where;

Vsubscan is the relative sub-scan speed of the coordinated motion,
Vmainscan is the relative main-scan speed of the coordinated motion, and θ is an angle representative of the degree of inclination of the feature portions;

t=Vsubscan/A subscan, where:

t is the time required to reduce Vsubscan to zero at a point (e.g. corner portion 55) in which the sub-scan motion is reciprocated, and
A subscan is the acceleration/deceleration required to establish change between Vsubscan and a zero speed at the reciprocation point, and

d=Vmainscan*t, where:

d is the distance traveled in the main-scan direction during time t.

By recombining equations (1), (2) and (3), distance d can be expressed as:

d=(Vmainscan2*sin θ)/A subscan.

For a typical conditions of Vmainscan=1 m/sec, deceleration a=5 m/sec2 and an angle θ=15 degrees, a distance d=51.7 mm would be required to reach a reciprocation point. For some demanding applications involving features comprising feature portions of varying angles, reciprocated coordinated motion would not practical. For example, in color filter applications, chevron shaped color features include inclined portions that are a hundred microns in length or less. An acceleration/deceleration distance d measured in millimeters would not be suitable for the imaging of such small features.

Other methods that can be employed to image skewed features or features with skewed edges include providing or modifying image data to reflect the amount of skew. Unlike imaging methods employing coordinated motion techniques, these techniques can result in the formation of features with edges that are non-continuous or interrupted. For example, channels 40 of imaging head 26 can be operated to transfer image pixels in a stair-case fashion as shown in FIG. 4B. FIG. 4B shows an enlarged view of a portion of a stripe feature 70 that overlaps color filter matrix line portion 60. In this case, coordinated motion is not employed in formation of stripe features 70 which have been formed with staircase-like edges. In this manner each of the features can be approximately formed including the formation of their respective corner portions 55.

Problems can arise when skewed features or features with skewed edges are formed with stair-cased edges. For example, in thermal transfer processes, various stress risers can be created along the stair-cased edges when a donor element 24 is peeled from the receiver element 18. These stress risers can result in an undesired removal of a portion of the transferred image forming material. Stress risers can promote the formation of edge discontinuities that can diminish the visual quality of the formed image. Problems can also arise when a one or more of these regions are to be formed in substantial alignment with a pattern of registration sub-regions. For example, in color filter applications, each color feature must be formed in substantial alignment with a cell belonging to a pattern of color filter matrix cells.

Overlapping portions of the matrix 20 may help to reduce the precision with which the color features must be aligned with the pattern of matrix cells. However, there typically are limits to the extent that a matrix can be overlapped. The imaging process employed can have an effect on the degree of overlap that is permitted. For example, the visual quality of an image produced in a laser-induced thermal transfer process is typically sensitive to the amount of image forming material that is transferred from donor element 24 to receiver element 18. The amount of transferred image forming material is typically sensitive to the spacing between the donor element 24 and receiver element 18. If adjacent features of different colors overlap themselves over portions of the matrix 20, the donor-to-receiver element spacing will additionally vary during the subsequent imaging of additional donors elements, possibly impacting the visual quality of the features imaged with these additional donor elements. In this regard, it is preferred that adjacent features of different colors not overlap themselves over a matrix portion. This requirement places additional alignment constraints on the required alignment between the pattern of repeating color features and the repeating pattern of matrix cells.

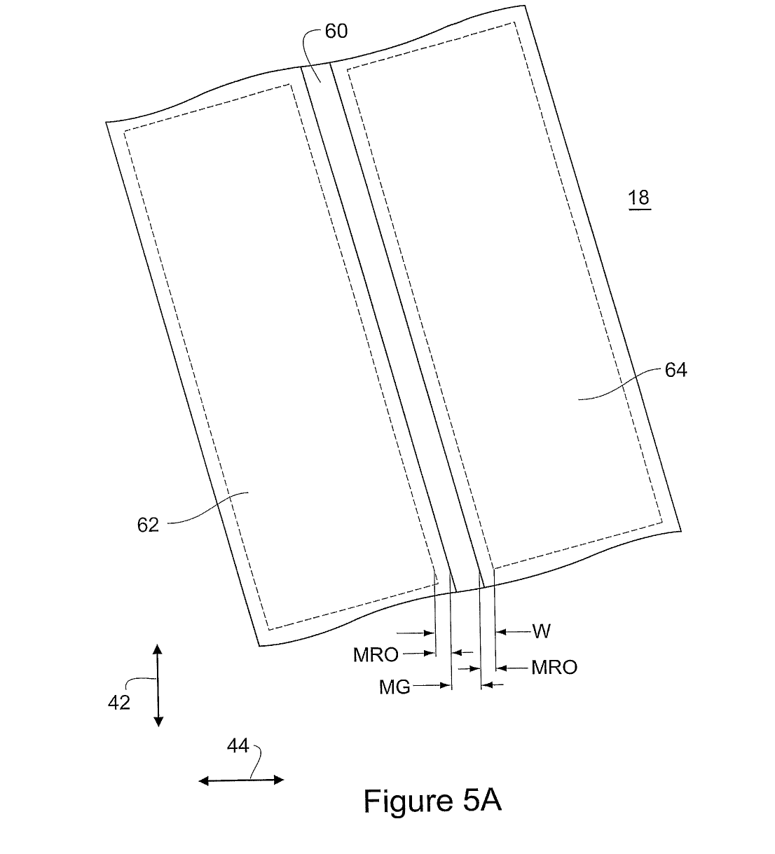

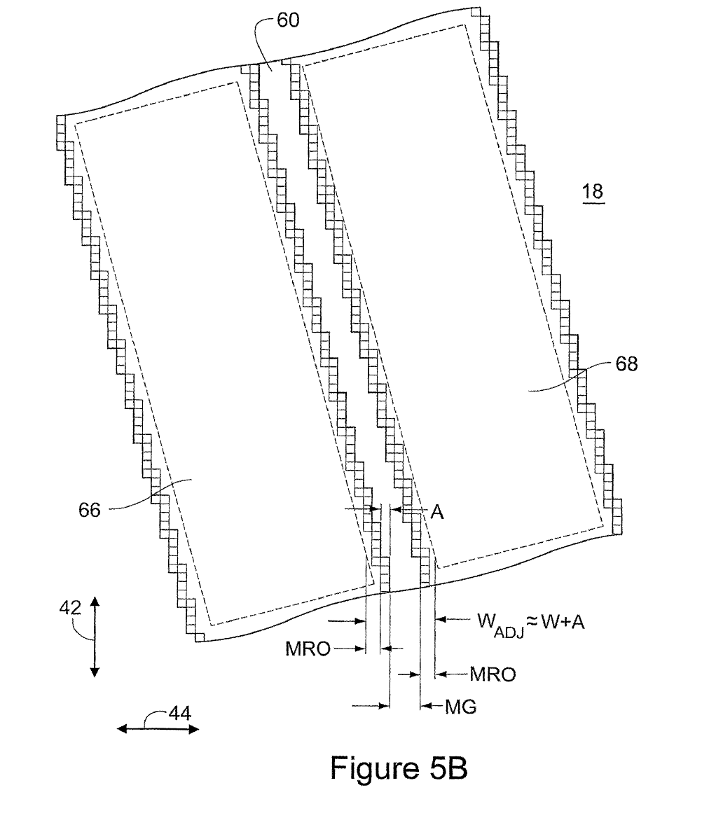

FIG. 5A shows two imaged features 62 and 64 with an inclined matrix portion 60. Features 62 and 64 were formed by scanning receiver element 18 with imaging beams. Coordinated motion techniques were employed to form the features 62 and 64 with substantially smooth continuous edges and substantially equal amounts of overlap on matrix portion 60. Various factors need to be considered when imaging color filter features such that they are aligned with matrix portion 60 without overlapping one another. For example, each of the features 62 and 64 are formed such that they overlap matrix portion 60 by a certain amount to achieve a desired quality characteristic of the color filter. In this case, each of the features 62 and 64 is required to overlap matrix portion 60 by a minimum required overlap (MRO) distance. Distance MRO is can be dependent on various factors. One such factor is the plotter accuracy of the imaging system used to image features 62 and 64. The plotter accuracy can be affected by the mechanical repeatability associated with the position of imaging head 26 during the imaging process, imaging beam drift and the edge roughness of the images that are formed. Another factor is the matrix repeatability which represents the variation in location of the matrix portion 60 with respect to receiver element 18 upon which it has been formed Another factor includes an absolute minimum required overlap required for various issues (e.g. feature shrinkage during an annealing process). Distance MRO can also be dependant on other factors.

In this case, each of the features 60 and 62 are separated from one another by a minimum gap MG. Distance MG is typically governed by the imaging repeatability associated with the imaging of each of the features 62 and 64.

Other factors can include the addressability A of imaging head 26. The ability to control the size of each of the imaged features 62 and 64 is function of pixel size. For example, effectively changing the size of each of the features 62 and 64 by one pixel effectively means that the position of an edge of each feature changes by one half pixel with respect to a corresponding edge of matrix portion 60. A half pixel of margin between the minimum gap MG and the minimum required overlap MRO is required for the imaging of each of the features. Accordingly, a minimum width W of matrix portion 60 required to image features 62 and 64 can be estimated by the following equation:

Width (W)=Addressability(A)+2×Minimum Required Overlap (MRO)+Minimum Gap (MG).

In some applications, imaging heads have addressabilities (A) as low as 5 microns. Typical minimum required overlaps (MRO) can be estimated to be approximately 4 microns while typical minimum gaps (MG) can be estimated to be approximately 5 microns. By using these typical levels, a minimum size W can be estimated to be approximately 18 microns. Some conventional color filters have matrix line widths in the order of 20 to 24 microns. It is desired to produce color filters with matrix line widths smaller than these conventional values. FIG. 5A shows that matrix portion has an appropriately sized width W that meets the MRO and MG requirements. In this case, W, MRO and MG are referenced with respect to sub-scan axis 44.

FIG. 5B shows two features 66 and 68 with an inclined matrix portion 60. Features 66 and 68 were formed by scanning receiver element 18 with imaging beams. Features 66 and 68 were not formed by employing coordinated motion techniques. Features 66 and 68 were formed with stair-case type edges. Such an imaging can be accomplished by employing image data that approximates the amount of skew desired in the edges. Although these “stair-cased” imaging techniques can be used to approximately form skewed features or features with skewed edges including chevron shaped features, problems can arise especially when these features must be formed in substantial alignment with a plurality of registration sub-regions.

An example of such a problem is shown in FIG. 5B. The stair-cased imaging of each of the features 66 and 68 creates stepped edges in which each step has a run (i.e. the run being aligned with sub-scan axis 44) equal to a multiple of the addressability A of the imaging head 26. The ability to control the size of each of the steps is function of pixel size. The position of the staggered portions of the edges accordingly changes additionally by multiples of a pixel size. To not impact minimum overlap requirements MRO and minimum gap requirements MG, the minimum size of matrix portion 60 is required to increase by an amount approximately equal to the addressability (e.g. Wadj≈W+A). Even with addressability values as low as 5 microns, a minimum matrix portion size is increased to 23 microns (i.e. 18 microns+5 microns addressability) for the typical values previously described. This conflicts with the desire to reduce the size of color filter matrix lines. In FIG. 5B W, MRO and MG are referenced with respect to sub-scan axis 44.

Referring back to FIG. 4A, it is desired to form the pattern of zig-zag stripe features feature 70 in substantial alignment with registration region 47. Each of the stripe features 70 included first portions 71 that assume a first inclination and second portions 72 that assume a second inclination. In this case the first inclination is different from the second inclination. In this case, first and second portions 71 and 72 are arranged to form a series of chevron shaped portions. Each of the chevron-shaped portions is to be formed in a substantial alignment with a pattern of registration sub-regions of registration region 47. In this case, the pattern of registration sub-regions can include color filter matrix 20A made up of pattern of chevron shaped matrix cells 34A which delineate each of the stripe features 70 into a plurality of features 75. The first portions 71 and the second portions 72 are inclined with respect to an axis 50 of the channel array 43. Each of the channels 40 can be controlled to form imaging line 49 while scanning over receiver element 18. In this case, the first portions 71 and the second portions 72 are inclined with respect to imaging lines 49. In this case, first portions 71 and second portions 72 are inclined with respect to sub-scan axis 44.

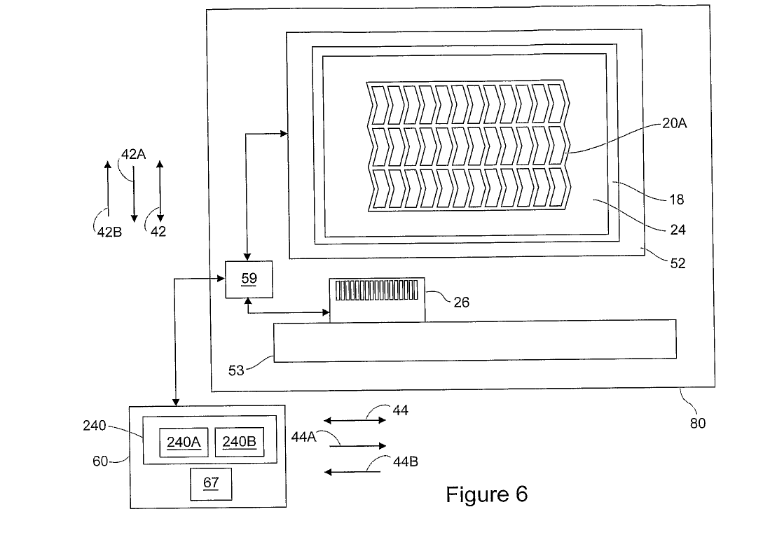

FIG. 6 schematically shows an apparatus 80 used in an example embodiment of the invention. Apparatus 80 is operable for forming images on receiver element 18. In this example embodiment of the invention, images are formed on receiver element 18 by operating imaging head 26 to direct imaging beams while scanning over receiver element 18. Apparatus 80 includes carrier 52 which is operable for conveying receiver element 18 along a path aligned with main-scan axis 42. Carrier 52 can move in a reciprocating fashion. In this example embodiment of the invention, carrier is movable along a forward direction 42A and a reverse direction 42B. Imaging head 26 is arranged on a support 53 that straddles carrier 52. Imaging head 26 is controlled to move along paths aligned with sub-scan directions 44. In this example embodiment of the invention imaging head 26 can be controlled to reciprocate along support 53. Imaging head 26 is movable along away direction 44A and along a home direction 44B.

In this example embodiment of the invention, a laser induced thermal transfer process is employed. Imaging head 26 is controlled to scan the media with a plurality of imaging beams to cause a transferal of an image forming material (not shown) from donor element 24 to receiver element 18. Imaging electronics control activation timing of the imaging channels 40 to regulate the emission of the imaging beams. Motion system 59 (which can include one or more motion systems) includes any suitable prime movers, transmission members, and/or guide members to cause the motion of carrier 52. In this example embodiment of the invention, motion system 59 controls the motion of imaging head 26 and controls the motion of carrier 52. Those skilled in the art will readily realize that separate motion systems can also be used to operate different systems within apparatus 80.

Controller 60, which can include one or more controllers, is used to control one or more systems of apparatus 50 including, but not limited to, various motion systems 59 used by carrier 52 and imaging head 26. Controller 60 can also control media handling mechanisms that can initiate the loading and/or unloading of receiver element 18 and donor element 24. Controller 60 can also provide image data 240 to imaging head 26 and control imaging head 26 to emit imaging beams in accordance with this data. Various systems can be controlled using various control signals and/or implementing various methods. Controller 60 can be configured to execute suitable software and can include one or more data processors, together with suitable hardware, including by way of non-limiting example: accessible memory, logic circuitry, drivers, amplifiers, A/D and D/A converters, input/output ports and the like. Controller 60 can comprise, without limitation, a microprocessor, a computer-on-a-chip, the CPU of a computer or any other suitable microcontroller. Controller 60 can be associated with a materials handling system, but need not necessarily be, the same controller that controls the operation of the exposure systems.

Apparatus 80 forms images in substantial alignment with the pattern of registration sub-regions. In this example embodiment of the invention, apparatus 80 forms various color filter patterns. The visual quality of each of the color filter feature patterns alone or combined is dependant on the final alignment between the formed features and the pattern of registration sub-regions. In this example embodiment of the invention, the visual quality is dependant upon the registration of the imaged color features with a matrix 20A.

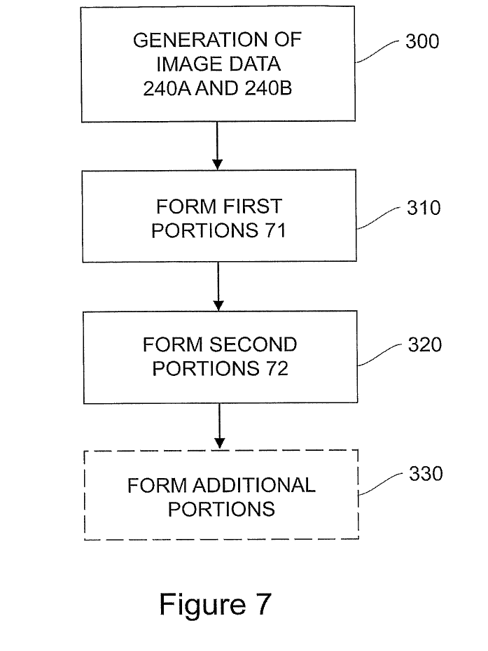

FIG. 7 shows a flow chart for imaging a pattern of features such as stripe features 70 shown in FIG. 4A as per an example embodiment of the invention. The FIG. 7 flow chart refers to apparatus 80 as schematically shown in FIG. 6, although it is understood that other apparatus are suitable for use with the illustrated process. The process begins a step 300 with the generation of image data 240A and 240B. Image data 240 representing the pattern of stripe features 70 can be separated into image data 240A and 240B. Image data 240A represents first portions 71 of each stripe feature 70 and image data 240B represents second portions 72 of each stripe feature 70. It is to be understood that features can include more than two portions and each portion may be associated with corresponding image data. Image data 240A and 240B are provided to imaging head 26 to respectively form first and second portions 71 and 72. In some embodiments of the invention, image data 240A and 240B can each be provided wholly or partially to imaging head 26. For example, each of image data 240A and 240B can provided to, or used by, imaging head 26 such that each is limited in size to an amount of data required to form a portion of an image during a single scan over receiver element 18. A sufficient amount of image data 240A can be provided to image head 26 to image a first image swath during a first scan over receiver element 18 and a sufficient amount of image data 240B can be provided to image head 26 to image a second image swath during a second scan over receiver element 18. Image data 240 can be buffered into bands of data consistent with the image data requirements of imaging head 26 during each scan over receiver element 18. In some example embodiments of the invention, image data 240 is separated prior to imaging. In some embodiments of the invention, image data 240 is separated during imaging. In some example embodiments of the invention, image data 240 is provided to controller 60 in a separated form.

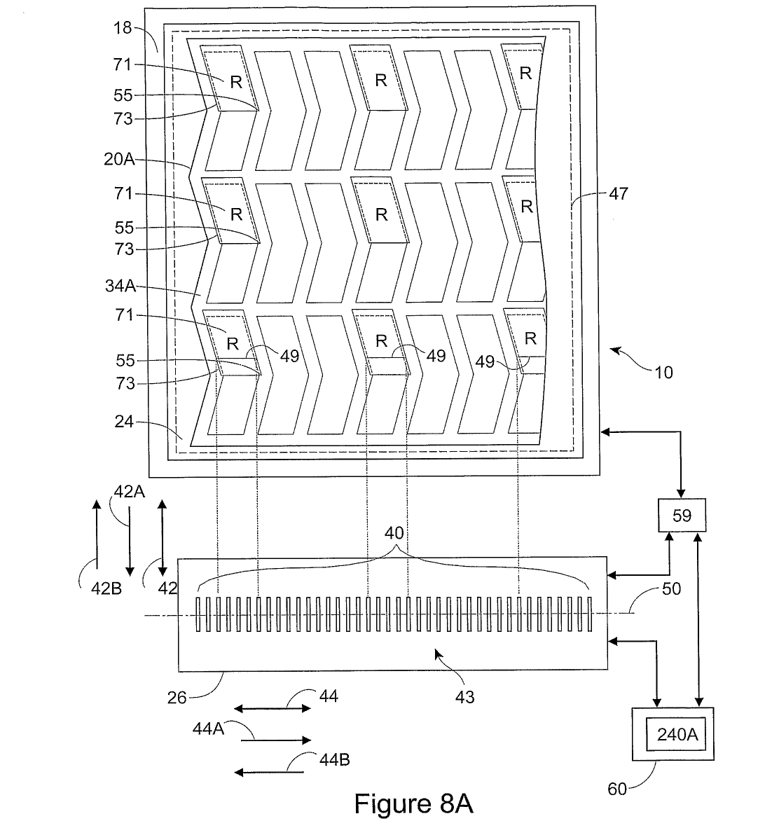

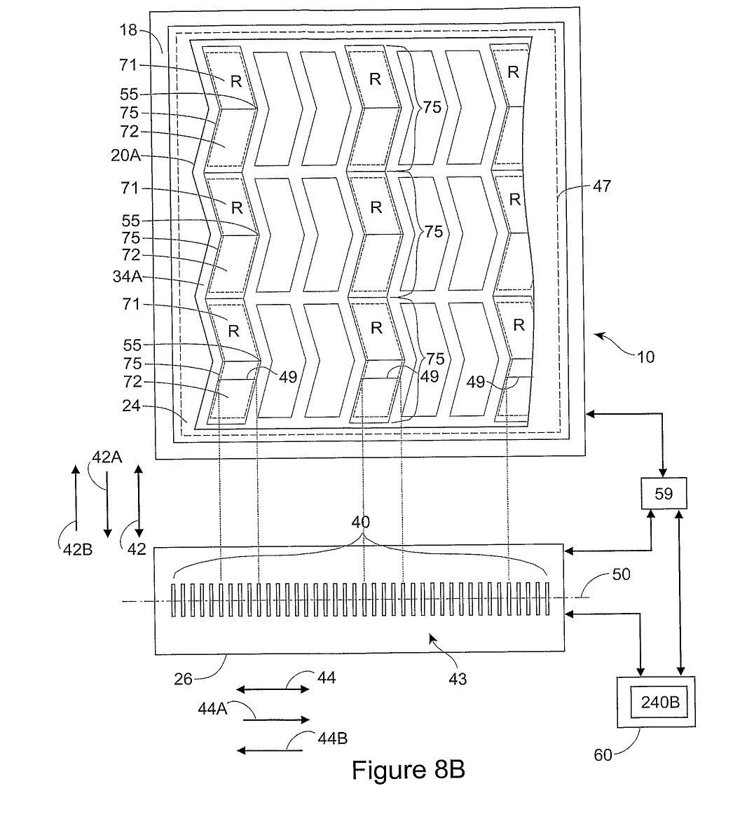

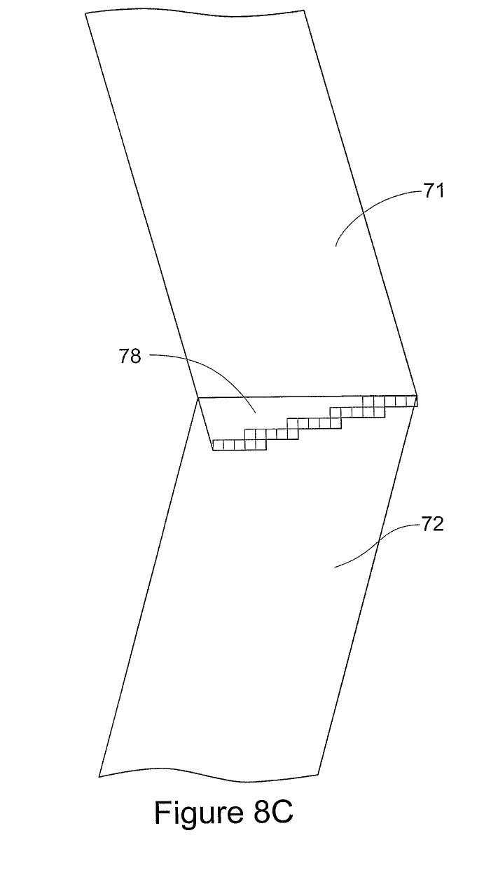

In step 310, imaging head 26 forms all or a part of first portions 71 during one or more scans over receiver element 18. The formation of first portions 71 on receiver element 18 is schematically represented in FIG. 8A. Controller 60 controls imaging head 26 to direct imaging beams along a first scan path to form portions 71 on receiver element 18. In this example embodiment of the invention, the first scan path is aligned with a first portion 71. A first portion 71 can be parallel to the first scan path. In this example embodiment of the invention, the first scan path is aligned with at least one edge of a first portion 71 (e.g. edge 73). The at least one edge of a first portion 71 can be parallel with the first scan path.

Controller 60 can control motion system 59 to define a first coordinated motion path for imaging head 26. Referring to FIG. 8A, imaging head 26 and receiver element 18 are synchronously moved with respect to one another during each scan in which first portions 71 are formed. In this example embodiment of the invention, sub-scan motion is coordinated with main-scan motion. Controller 60 establishes the first coordinated motion by controlling motion system 59 such that its sub-scan servo target position is directly tied in real time to main-scan motion. As main-scan motion is established, the required synchronous sub-scan motion is defined to create oriented image swaths. Coordinated motion techniques can be used to form a first portion 71 which are aligned with the first coordinated motion path. A first portion 71 can be parallel to the first coordinated motion path. Coordinated motion techniques can be used to form a first portion 71 with at least one edge that is aligned with the first coordinated motion path. The at least one edge can be parallel to the first coordinated motion path. Coordinated motion techniques can be used to form a first portion 71 that includes at least one edge that is smooth and continuous. When multiple first portions 71 are imaged during a single scan, imaging head 26 can assume different positions with respect to sub-scan axis 44 as it images different first portions 71. Different first portions 71 can be imaged by different groups of imaging channels 40. Imaging head 26 can be appropriately positioned at the start of the scan to image multiple first portions 71 along the scan.

In step 320, imaging head 26 forms all or a part of portions 72 during one or more scans over receiver element 18 as shown in FIG. 8B. Controller 60 controls imaging head 26 to direct imaging beams along a second scan path to form second portions 72 on receiver element 18. In this example embodiment of the invention, the second scan path is aligned with a second portion 72. A second portion 72 can be parallel to the second scan path. In this example embodiment of the invention, the second scan path is aligned with at least one edge of a second portion 72 (e.g. edge 75). The at least one edge of a second portion 72 can be parallel with the second scan path. The second scan path used to form a second portion 72 is not parallel with the first scan path used to form a first portion 71. In some example embodiments, a pause or stop in the scanning defines the boundary between the first and second scans.

Controller 60 can control motion system 59 to define a second coordinated motion path for imaging head 26. Referring to FIG. 8B, imaging head 26 and receiver element 18 are synchronously moved with respect to one another during each scan in which second portions 72 are formed. In this example embodiment of the invention, sub-scan motion is coordinated with main-scan motion. Controller 60 establishes the second coordinated motion by controlling motion system 59 such that its sub-scan servo target position is directly tied in real time to main-scan motion. As main-scan motion is established, the required synchronous sub-scan motion is defined oriented image swaths. Coordinated motion techniques can be used to form second portions 72 which are aligned with the second coordinated motion path. Second potions 72 can be parallel to the second coordinated motion path. Coordinated motion techniques can be used to form second portions 72 with at least one edge that is aligned with the second coordinated motion path. The at least one edge of second portion 72 can be parallel to the second coordinated motion path. Coordinated motion techniques can be used to form second portions 72 that include at least one edge that is smooth and continuous. The second coordinated motion path is different from the first coordinated motion path. In this example embodiment of the invention, the second coordinated motion path and the first coordinated motion path are not parallel to one another. When multiple second portions 72 are imaged during a single scan, imaging head 26 can assume different positions with respect to sub-scan axis 44 as it images different second portions 72. Different second portions 72 can be imaged by different groups of imaging channels 40. Imaging head 26 can be appropriately positioned at the start of the scan to image multiple second portions 72 throughout the scan.

Step 330 is optional and is accordingly represented by broken lines. Step 330 includes the formation of additional feature portions. Additional feature portions can be the same or different from first or second feature portions 71 and 72.

In some example embodiments of the invention, a first portion 71 is formed on receiver element 18 as at least one of imaging head 26 and receiver element 18 is moved in a first direction while a second portion 72 is formed on receiver element 18 as the at least one of imaging head 26 and receiver element 18 is moved in a second direction. In some example embodiments of the invention the first direction is the same as the second direction while in other example embodiments of the invention, the first direction is different from the first direction. In some example embodiments of the invention, the first direction is not parallel to the second direction. In some example embodiments of the invention, the first direction is a forward direction and the second direction is reverse direction. In some example embodiments of the invention, receiver element 18 is moved in forward main-scan direction 42A as each of a first portion 71 and a second portion 72 are formed on receiver element 18. In some example embodiments of the invention, receiver element 18 is moved in reverse main-scan direction 42B as each of a first portion 71 and a second portion 72 are formed on receiver element 18. In some example embodiments of the invention, receiver element 18 is moved in forward main-scan direction 42A as a first portion 71 is formed on receiver element 18 and moves in reverse direction 42B as a second portion 72 is formed on receiver element 18. In some example embodiments of the invention, imaging head 26 is moved in away direction 44A as each of a first portion 71 and a second portion 72 are formed on receiver element 18. In some example embodiments of the invention, imaging head 26 is moved in home direction 44B as each of a first portion 71 and a second portion 72 are formed on receiver element 18. In some example embodiments of the invention, imaging head 26 is moved in away direction 44A as a first portion 71 is formed on receiver element 18 and moves in home direction 44A as a second portion 72 is formed on receiver element 18.

In some example embodiments of the invention, at least one of imaging head 26 and receiver element 18 are moved by different amounts during each of the first and second scans. In some example embodiments of the invention, scanning along the first scan path includes scanning in a first direction and scanning along the second path includes scanning along a second direction. Images can be formed by repeatedly scanning along the first direction and the second direction, such that each scan along the first direction alternates with each scan along the second direction.

As shown in FIG. 8B, formed first portions 71 are formed in abutted relationship with formed second portions 72. In other embodiments of the invention, formed first portion 71 overlaps formed second portion 72. FIG. 8C shows an example of overlapped first and second portions 71 and 72. In this example first and second portions 71 and 72 are formed to create an overlapped portion 78. Overlapping first portions 71 and second portions 72 can help to reduce registration errors between the two. Those skilled in the art will quickly realize that different forms of overlaps can be employed. In some embodiments of the invention, image data 240A and 240B can be modified to cause a first portion 71 to be overlapped by a second portion 71. In some embodiments of the invention, an activation timing of imaging head 26 during the formation of a first portion 71 can be varied from the activation timing of imaging head 26 during the formation of a second portion 72. An activation timing of imaging head 26 can be varied to cause a second portion 72 to overlap a first portion 71. Each of first and second portions 71 and 72 can be formed to partially or fully overlap a plurality of registration sub-regions. Without limitation, a plurality of registration sub-regions can include a pattern of registration sub-regions or a repeating pattern of registration sub-regions. A pattern of registration sub-regions can include a matrix.

Features 70 are shown to comprise zig-zag portions or chevron-shaped portions for the purpose of example only and those skilled in the art will realize that other shaped features can be formed as per various example embodiments of the invention.

Imaging head 26 may comprise any suitable multi-channel imaging head having individually-addressable channels, each channel capable of producing an imaging beam having an intensity or power that can be controlled. Imaging head 26 may provide a one-dimensional or two-dimensional array of imaging channels. Any suitable mechanism may be used to generate imaging beams. The imaging beams may be arranged in any suitable way.

Some embodiments of the invention employ infrared lasers. Infrared diode laser arrays employing 150 μm emitters with total power output of around 50 W at a wavelength of 830 nm can be used. Alternative lasers including visible light lasers may also be used in practicing the invention. The choice of laser source employed may be motivated by the properties of the media to be imaged.

Various example embodiments of the invention have been described in terms of a laser induced thermal transfer processes in which an image forming material is transferred to a receiving element. Other example embodiments of the invention can be employed with other imaging methods and media. Images can be formed on media by different methods without departing from the scope of the present invention. For example, media can include an image modifiable surface, wherein a property or characteristic of the modifiable surface is changed when irradiated by an imaging beam to form an image. An imaging beam can be used to ablate a surface of media to form an image. Those skilled in the art will realize that different imaging methods can be readily employed.

A program product 67 can be used by controller 60 to perform various functions required by apparatus 50. One such function can include separating image data 240. One such function can include varying the activation timing of imaging head 26 during the imaging of a first portion 71 of a feature and during the imaging of a second portion 72 of a feature. One such function can include modifying image data 240 to cause a first portion of a feature to be overlapped with a second portion 72 of a feature. Without limitation, program product 67 can be used to cause imaging head 26 to direct imaging beams to form a portion of an image on receiver element 18 while scanning over receiver element 18 along a first scan path during a first scan and cause imaging head 26 to direct imaging beams to form an additional portion of the image on receiver element 18 along a second scan path during a second scan such that the first scan path is not parallel to the second scan path. Program product 67 can be used to cause imaging head 26 to form a portion of an image on receiver element 18 while establishing a first coordinated motion path between imaging head 26 and receiver element 18 during a first scan and form an additional portion of the image on receiver element 18 while establishing a second coordinated motion path between imaging head 26 and receiver element 18 during a second scan such that the first coordinated motion path is not parallel to the second coordinated motion path. Without limitation, program product 67 can comprise any medium which carries a set of computer-readable signals comprising instructions which, when executed by a computer processor, cause the computer processor a method as described herein. Program product 67 can comprise, for example, physical media such as magnetic storage media including, floppy diskettes, hard disk drives, optical data storage media including CD ROMs, DVDs, electronic data storage media including ROMs, flash RAM, or the like. The instructions can optionally be compressed and/or encrypted on the medium.

Features 70 may be imaged in accordance with image data 240 that includes halftone screening data. In halftone imaging, features comprise a pattern of elements known halftone dots. The halftone dots vary in size according to the desired lightness or darkness of the imaged feature. Each halftone dot is typically larger than pixels imaged by imaging head 26 and is typically made up of a matrix of pixels imaged by a plurality of imaging channels. Halftone dots are typically imaged at a chosen screen ruling typically defined by the number of halftone dots per unit length and a chosen screen angle typically defined by an angle at which the halftone dots are oriented. In example embodiments of the invention, a feature 70 may be imaged with a screen density in accordance with the corresponding halftone screen data chosen to image that feature.

In other example embodiments of the invention, a feature 70 may be imaged with stochastic screen made up of a varying spatial frequency of equally sized dots. In yet other example embodiments of the invention, a non-contiguous feature may be imaged with a combined halftone and stochastic screen (commonly referred to as a “hybrid” screen).

Patterns of features have been described in terms of patterns of color features in a display. In some example embodiments of the invention, the features can be part of an LCD display. In other example embodiments of the inventions, the features can be part of an organic light-emitting diode (OLED) display. OLED displays can include different configurations. For example, in a fashion similar to LCD display, different color features can be formed into a color filter used in conjunction with a white OLED source. Alternatively, different color illumination sources in the display can be formed with different OLED materials with various embodiments of the invention. In these embodiments, the OLED based illumination sources themselves control the emission of colored light without necessarily requiring a passive color filter. OLED materials can be transferred to suitable media. OLED materials can be transferred to a receiver element with laser-induced thermal transfer techniques.

While the invention has been described using as examples applications in display and electronic device fabrication, the methods described herein are directly applicable to imaging any patterns of features including those used in biomedical imaging for lab-on-a-chip (LOC) fabrication. LOC devices may include several repeating patterns of features. The invention may have application to other technologies, such as medical, printing and electronic fabrication technologies.

It is to be understood that the exemplary embodiments are merely illustrative of the present invention and that many variations of the above-described embodiments can be devised by one skilled in the art without departing from the scope of the invention.

What is claimed is:

1. A method for forming an image on a media comprising:
operating an imaging head comprising an array of individually addressable channels to direct imaging beams to form a first portion of the image on the media while scanning over the media along a first scan path during a first scan; and
operating the imaging head to direct imaging beams to form a second portion of the image on the media while scanning over the receiver element along a second scan path during a second scan, wherein the first scan path is not parallel to the second scan path.

2. A method according to claim 1, wherein the first portion of the image comprises a portion of a feature, and wherein the portion of the feature is parallel to the first scan path.

3. A method according to claim 1, wherein the first portion of the image comprises a portion of a feature, and wherein at least one edge of the portion of the feature is parallel to the first scan path.

4. A method according to claim 2, wherein the second portion of the image comprises an additional portion of the feature.

5. A method according to claim 4, wherein the additional portion of the feature is parallel to the second scan path.

6. A method according to claim 4, wherein at least one edge of the additional portion of the feature is parallel to the second scan path.

7. A method according to claim 1, wherein the first portion of the image comprises a portion of a feature and the second portion of the image comprises an additional portion of the feature, the method comprising overlapping the portion of the feature with the additional portion of the feature.

8. A method according to claim 1, comprising establishing relative motion between the imaging head and the media during at least one of the first and second scans.

9. A method according to claim 1, comprising establishing relative motion between the imaging head and the media along a first path during the first scan and establishing relative motion between the imaging head and the media along a second path during the second scan, wherein the first path is different from the second path.

10. A method according to claim 1, comprising moving at least one of the media and the imaging head in a first direction during the first scan and moving the at least one of the media and the imaging head in a second direction during the second scan, wherein the second direction is different from the first direction.

11. A method according to claim 10, wherein the second direction is the reverse of the first direction.

12. A method according to claim 10, wherein the first direction is a forward direction and the second direction is a reverse direction.

13. A method according to claim 10, wherein the first direction is an away direction and the second direction is a home direction.

14. A method according to claim 1, comprising moving at least one of the media and the imaging head by different amounts during each of the first and second scans.

15. A method according to claim 1, comprising operating the imaging head in accordance with image data provided to the imaging head, the method comprising separating the image data into image data portions corresponding to the first portion of the image and the second portion of the image.

16. A method according to claim 7, comprising operating the imaging head in accordance with image data provided to the imaging head, the method comprising modifying the image data to overlap the portion of the feature with the additional portion of the feature.

17. A method according to claim 1, wherein the media comprises a plurality of registration sub-regions, the method comprising aligning the first scan path to form the first portion of the image in substantial registration with a first registration sub-region.

18. A method according to claim 1, wherein the media comprises one or more registration sub-regions, the method comprising aligning the first scan path to form the first portion of the image in substantial registration with a first registration sub-region by causing relative motion in both a main scan direction and a sub-scan direction.

19. A method according to claim 17, comprising aligning the second scan path to form the second portion of the image in substantial registration with one of the plurality of registration sub-regions.

20. A method according to claim 1, wherein the image comprises a repeating pattern of features.

21. A method according to claim 20, wherein the repeating pattern of features comprises a repeating pattern of island features.

22. A method according to claim 1, wherein the image comprises a chevron shaped feature.

23. A method according to claim 1, wherein the image comprises a feature, wherein a portion of the feature is skewed with respect to a main-scan direction.

24. A method according to claim 1, wherein the media comprises a pattern of registration sub-regions, and the image comprises one or more patterns of features, the method comprising registering the one or more patterns of features with the pattern of registration sub-regions.

25. A method according to claim 24, wherein the pattern of registration sub-regions comprises a matrix, and the one or more pattern of features comprises a pattern of color features.

26. A method according to claim 25, wherein the pattern of color features forms a portion of a color filter.

27. A method according to claim 25, wherein the pattern of color features forms a pattern of colored illumination sources.

28. A method according to claim 27, wherein the colored illumination sources comprises an OLED material.

29. A method according to claim 25, wherein the one or more patterns of features comprises a plurality of patterns of color features, each pattern of color features corresponding to a given color, the method comprising imaging each of the patterns of color features separately.

30. A method according to claim 1, comprising forming at least one of the first portion of the image and the second portion of the image in a laser-induced thermal transfer process.

31. A method according to claim 30, wherein the laser-induced thermal transfer process comprises a laser-induced dye-transfer process.

32. A method according to claim 30, wherein the laser induced thermal transfer process comprises a laser-induced mass transfer process.

33. A method according to claim 30, wherein the laser induced thermal transfer process comprises transferring an image forming material from a donor element to a receiver element.

34. A method according to claim 33, wherein the image forming material comprises an OLED material.

35. A method according to claim 21, wherein the repeating pattern of island features comprises a first plurality of features of a first color, each feature of the first plurality separated from each other feature of the first color by a feature of a different color.

36. A method according to claim 9, wherein the first path is not parallel to the second path.

37. A method for forming an image on a media comprising:
operating an imaging an imaging head comprising an array of individually addressable channels to direct imaging beams to form the image on the media during a plurality of scans;
moving the imaging head relative to the media along a first path during a first scan; and
moving the imaging head relative to the media along a second path during a second scan, wherein the second path is not parallel to the first path.

38. A method according to claim 37, wherein the first path comprises first coordinated motion path.

39. A method according to claim 38, wherein the second path comprises a second coordinated motion path.

40. A method according to claim 37, comprising moving the both the imaging head and the media during at least one of the first scan and the second scan.

41. A method according to claim 40, wherein moving both the imaging head and the media comprises synchronously moving the imaging head and media.

42. A method according to claim 37, comprising moving at least one of the media and the imaging head along a first direction during the first scan and moving the at least one of the media and the imaging head along a second direction during the second scan, wherein the second direction is different from the first direction.

43. A method according to claim 42, wherein the second direction is the reverse of the first direction.

44. A method according to claim 37, comprising moving at least one of the media and the imaging head by different amounts during each of the first scan and the second scan.

45. A method according to claim 37, wherein the media comprises a pattern of registration sub-regions, and the image comprises one or more patterns of features, the method comprising registering the one or more patterns of features with the pattern of registration sub-regions.

46. A method according to claim 45, wherein the pattern of registration sub-regions comprises a matrix, and the one or more pattern of features comprises a pattern of color features.

47. A method according to claim 37, comprising forming the image in a laser-induced thermal transfer process.

48. A program product carrying a set of computer-readable signals comprising instructions which, when executed by a controller, cause the controller to:
operate an imaging head comprising an array of individually addressable channels to direct imaging beams to form a first portion on an image on a media while scanning over the media along a first scan path during a first scan; and
operate the imaging head to direct imaging beams to form a second portion of the image on the media while scanning over the media along a second scan path during a second scan;
wherein the first scan path is not parallel to the second scan path.

49. A program product carrying a set of computer-readable signals comprising instructions which, when executed by a controller, cause the controller to:
operate an imaging an imaging head comprising an array of individually addressable channels to direct imaging beams to form the image on a media during a plurality of scans;
move the imaging head relative to the media along a first coordinated motion path during a first scan; and
move the imaging head relative to media along a second coordinated motion path during a second scan, wherein the second coordinated motion path is not parallel to the first coordinated motion path.

50. A method according to claim 1, comprising pausing the scanning between the first and second scans.

51. A method according to claim 37, comprising pausing the movement of the imaging head relative to the media between the first and second scans.

52. A method according to claim 1, wherein scanning along the first scan path comprises scanning in a first direction and scanning along the second path comprises scanning along a second direction, the method comprising repeatedly scanning along the first direction and the second direction, wherein each scan along the first direction alternates with each scan along the second direction.

53. A method according to claim 2, wherein the portion of the feature is not parallel to an axis of the array of individually addressable channels.

54. A method according to claim 3, wherein the at least one edge of the portion of the feature is not parallel to an axis of the array of individually addressable channels.

55. A method according to claim 53, wherein the second portion of the image comprises an additional portion of the feature, wherein the additional portion of the feature is parallel to the second scan path and is not parallel to the axis of the array of individually addressable channels.

56. A method according to claim 53, wherein the second portion of the image comprises an additional portion of the feature, wherein at least one edge of the additional portion of the feature is parallel to the second scan path and is not parallel to the axis of the array of individually addressable channels.
